(19) United States
(12) Patent Application Publication
(10) Pub. No.: US 2003/0052192 A1
(43) Pub. Date: Mar. 20, 2003

(54) Auto-care irrigation and conditioning system and method

(76) Inventor: Trent Kerr, Cypress, TX (US)

Correspondence Address: H. Dale Langley, Jr., The Law Firm of H. Dale Langley, Jr., PC, 610 West Lynn, Austin, TX, 78703, US

(21) Appl. No.: 10/244,950

(22) Filed: Sep. 17, 2002

Related U.S. Application Data
(60) Provisional application No. 60/322,930, filed on Sep. 18, 2001.

(51) Int. Cl. A62C 5/02; B05B 7/26

(52) U.S. Cl. 239/310; 239/569; 137/268

(57) ABSTRACT

A system mixes a chemical or other substance with a flowing liquid, such as water, for dispensation on a lawn, garden or other tract. The system includes a pipe containing the flowing liquid. A first reservoir is connected to the pipe and receives a portion of the flowing liquid. The first reservoir contains the substance and permits the substance to mix with the flowing liquid. After mixing, the flowing liquid mixed with the substance flows from the first reservoir back into the pipe. The system can also include a second reservoir also connected to the pipe. The second reservoir can also or alternatively receive a portion of the flowing liquid. The second reservoir contains either the same or a different chemical or other substance and permits the substance to mix with the flowing liquid. The flowing liquid after mixing with the substance flows from the second reservoir into the pipe. The pipe passes the liquid with mixed substance to a desired location of the tract. The first reservoir can serve to contain a solid chemical substance, such as pellets, powders, or porous solid, and the second reservoir can serve to contain a liquid chemical substance. The substances can be a fertilizer, a pesticide, a herbicide or other lawn or garden treatment.

### BACKGROUND OF THE INVENTION

The present invention generally relates to turf and plant care systems and methods and, more particularly, relates to automated irrigation and chemical dispersion systems and methods for lawns, gardens, fields, turf plots and the like.

Homeowners and landscapers contracted to care for residential, commercial or institutional properties are familiar with the conventional irrigation and dispersion systems for use on the scale of the typical grass lawn or other plant tracts in these environments. Such systems typically include garden hosing or poly-vinylchloride (PVC) piping networks, as well as possibly various sprinkler outlet and automation devices. In the case of garden hosing, the irrigation operations are typically not automated, and the hose must be physically moved by the human caretaker.

In typical piping networks, the networks are rigid and fixed, usually located subsurface except for the surface protruding outlet sprinkler heads selectively located in fixed locations of the tract. These conventional irrigation systems are typically not equipped with any chemical dispersion mechanisms, for example, fertilizer, pesticide, herbicide or other chemical spreading features. Instead, the typical chemical dispersion mechanisms employed by tract caretakers in these environments are wheeled or handheld mechanical spreaders for solid chemicals dispersion, handheld sprayer guns with integrated chemical reservoir for mixing of liquid or solid chemicals for spray dispersion, pressurized tank and sprayer systems having large mixing reservoirs for liquid or solid chemicals for spray or drip dispersion, and other manual dispersion of chemicals from bags, watering kettle, and similar containers.

Over the last decade or so, a trend in the lawn care and landscaping business, particularly with respect to consuming homeowners and other small-scale caretaker tracts, has been to provide products and systems that automate much of the tract management activities that had previously required manual, hands-on work of the human caretaker. For example, many homes now have lawns and gardens equipped with automated watering systems, comprising networks of underground piping and sprinkler heads. These automated systems are often electronically controlled and allow for pre-set timings and operations, even when the human caretaker is not available or present.

Consumer fertilizer, pesticide, herbicide and similar chemicals spreading systems are generally less automated. Typically, the human caretaker must physically spread and apply such chemicals to the managed tract or lawn. For example, the caretaker can spread palletized or other solid chemicals via pushing a rolling spreader or walking across the tract while operating a mechanical handheld disperser. Certain systems for spreading such chemicals have alternatively included reservoirs associated with a pressurized water or other flowing liquid source, such as a garden hose. In these systems, the human caretaker must typically handle and locate a similarly associated sprayer nozzle or mechanism in order to obtain the desired dispersion of the chemicals which are mixed with the pressurized flowing liquid in the reservoir. Of course, even more basic manual techniques for applying these chemicals continue to be employed, such as, for example, the caretaker can merely shake and move a container (e.g., a bag, sack, bottle, or other container) of the solid or liquid chemicals as the caretaker walks across the tract.

As can be appreciated, the conventional irrigation and chemicals applicator systems and methods present problems and inconveniences. Significant problems and inconveniences include such matters as equipment wieldiness, manual labor requirements, manual observation and placement, weightiness, corrosiveness and damages sustained through normal usage, maintenance complexity and requirements, cost, inaccuracy and inefficiency, exposure of harmful substances, waste, complexity of installation and use, and others. To alleviate or reduce these problems and inconveniences would be a boon to lawn and garden caretakers and others desiring to ease and automate irrigation and chemical dispersion. Moreover, economical solutions would, no doubt, be favorable to homeowner consumers and the public.

It would, thus, be a significant improvement in the art and technology to provide automated irrigation and chemical dispersion systems and methods that provide these and other solutions and advantages.

### SUMMARY OF THE INVENTION

An embodiment of the invention is a chemical dispersion system for transporting a liquid. The system includes a liquid conduit, a reservoir flowingly connected to the liquid conduit, and a mechanism for regulating flows from the liquid conduit through the reservoir and back into the liquid conduit.

In certain aspects, the reservoir contains a substance selected from the group consisting of: solid, gas, liquid, and multiphase; the mechanism regulates flows into the reservoir; or the mechanism regulates flows from the reservoir.

In certain other aspects, the system includes a second reservoir flowingly connected to the liquid conduit and a second mechanism for regulating flows from the liquid conduit through the second reservoir and back into the liquid conduit.

Yet other aspects include a solid chemical maintained within the reservoir. Flows from the liquid conduit into the reservoir mix with the solid chemical and saturate flows out of the reservoir back into the liquid conduit.

In other aspects, the chemical maintained within the reservoir for mixing with the flows from the liquid conduit is fertilizer, herbicide, or pesticide.

In further aspects, the solid chemical can be pellets, granules, powder, or other porous media.

Moreover in certain aspects, the reservoir can serve to contain a solid chemical and the second reservoir can serve to contain a liquid chemical. The solid chemical can be the same as, or can have a different composition than, the liquid chemical.

Another embodiment of the invention is a system for mixing a substance with a flowing liquid. The system includes a pipe containing the flowing liquid,,a first reservoir connected to the pipe for receiving at least a portion of the flowing liquid, the first reservoir contains the substance and permits the substance to mix with the flowing liquid, and the flowing liquid after mixing with the substance flows from the first reservoir into the pipe.

In another aspect, the system includes a second reservoir connected to the pipe for receiving at least a portion of the flowing liquid, the second reservoir contains the substance and permits the substance to mix with the flowing liquid, and the flowing liquid after mixing with the substance flows from the second reservoir into the pipe.

In further aspects, each of the first reservoir and the second reservoir contain different substances which can be fertilizer, herbicide or pesticide. In other aspects, the substances can be solid, liquid, gas and multiphase.

Yet another embodiment of the invention is a method of dispersing a chemical in a liquid. The method includes retaining the chemical in a container, flowing the liquid in a conduit, passing at least a portion of the liquid from the conduit into the container, mixing the liquid with the chemical in the container, and passing the liquid as mixed with the chemical back into the conduit.

In other aspects, the chemical of the method can be solid, liquid, gas, or multiphase.

In another aspect, the method includes controlling an extent of saturation of the chemical in the liquid.

In yet a further aspect, the chemical of the method is a fertilizer, herbicide, and pesticide.

In other aspects, the method includes retaining the chemical in a second container, passing at least a portion of the liquid from the conduit into the second container, mixing the liquid with the chemical in the second container, and passing the liquid as mixed with the chemical back into the conduit.

In other aspects, the container contains a first chemical and the second container contains a second chemical.

In further aspects, the method includes controlling an extent of saturation of the first chemical in the liquid and controlling an extent of saturation of the second chemical in the liquid.

In certain aspects, the method waters a tract of land.

In certain aspects, the chemical dispersion system includes a watering conduit for delivering water to a tract of land.

### BRIEF DESCRIPTION OF THE DRAWINGS

The present invention is illustrated by way of example and not limitation in the accompanying figures, in which like references indicate similar elements, and in which:

FIG. 1 illustrates a perspective view of an automatic irrigation and conditioning system for use for a lawn, garden, or other tract, containing dual reservoirs for mixing chemicals, such as, for example, solid or liquid fertilizer, herbicide or pesticide, with irrigation water for deposition on the tract, all according to certain embodiments of the present invention;

FIG. 2 illustrates a side view of the system of FIG. 1; and

FIG. 3 illustrates a top view of the system of FIGS. 1 and 2.

### DETAILED DESCRIPTION OF PREFERRED EMBODIMENTS

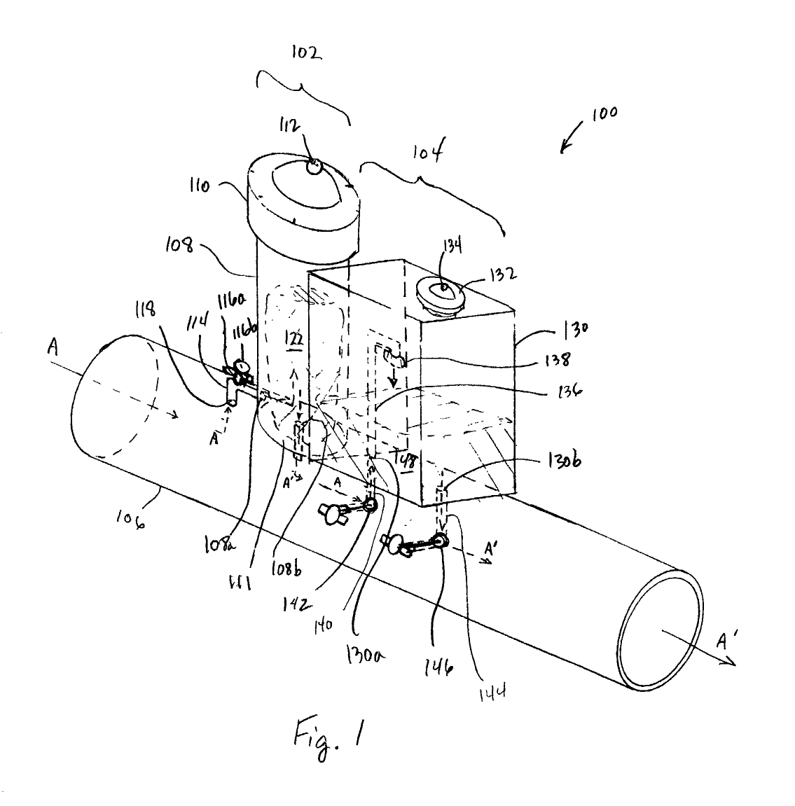

Referring to FIG. 1, a system 100 for automated irrigation and chemical dispersion for use for lawns and the like includes a first reservoir 102 and a second reservoir 104. Each of the first reservoir 102 and the second reservoir 104 are connected to a pipe 106. The connection of the first reservoir 102 to the pipe 106 permits an inlet fluid flow A from the pipe 106 to enter the first reservoir 102 and, then, to exit from the first reservoir 102 back into the pipe 106 providing an outlet fluid flow A′. The second reservoir 104 is connected to the pipe 106 also to permit the inlet fluid flow A from the pipe 106 to enter the second reservoir 104, then to exit the second reservoir 104 back into the pipe 106 to provide the outlet fluid flow A′.

The first reservoir 102 is, for example, a cylindrical container 108 vertically disposed atop the pipe 106. The cylindrical container 108 includes a cylindrical cap 110, which can be snap-on, threaded, or other configuration to mate with the cylindrical container 108 at its uppermost opening disposed from the connection with the pipe 106. Of course, the cylindrical container 108, at this uppermost opening, will necessarily include matching mate configurations so that the cap 110 seals the opening of the container 108 in desired manner. The cap 110 can include additional features and mechanisms, such as, for example, a pressure relief or other emissions fixture, opening or valve 112.

In the system 100, each of the inlet and outlet fluid flow connections of the first reservoir 102 and the second reservoir 104 to the pipe 106 are regulatable, such as by valves, block-offs, inlet and outlet connection sizing, or other mechanism to limit or vary flows into and out of the reservoirs 102, 104. Particularly, at a side of the cylindrical container 108 near the connection of the container 108 with the pipe 106, the side of the container 108 includes an inlet hole 108a. The inlet hole 108a allows for the inlet flow A from the pipe 106 to enter the container at a lower location along the cylindrical container 108, when the container 108 is vertically attached in position atop the pipe 106 when horizontally disposed. As will be hereafter more fully explained, the inlet hole 108a, as so positioned in the container 108, permits fluids A to flow from the pipe 106 into and up through the cylindrical container 108. In the container 108, the fluids mix with any substance, such as granulated chemicals, disposed in the container 108, prior to exiting the container 108 back to the pipe 106 as fluids A′.

At an end of the cylindrical container 108 at the pipe 106, the container 108 includes a permanently affixed enclosure forming a bottom 111 of the container 108. The bottom enclosure 111 is either formed during manufacture of the cylindrical container 108 as an integral part thereof, or is affixed with the cylindrical container 108 by glue, adhesive, welding, or other attachment means. The bottom enclosure 111 includes a hole 108b centrally disposed in the enclosure 111. The hole 108b allows exit of the fluids and mixed substances within the container 108, out of the container 108 and into the pipe 106. The hole 108b flowingly communicates with a mated opening in the pipe 106. As will be further described herein, fluids A flowing into the pipe 106 enter the container 108 through the hole 108a and flow upward into the container 108 and mix with substances in the container 108. The fluids A′, then, after mixing with the substances, flow out of the container 108 through the hole 108b, and back into the pipe 106.

At the inlet hole 108a of the cylindrical container 108, an inlet pipe 114 connects to the container 108 in order to feed the container 108 at the inlet hole 108a. The inlet pipe 114 is connected at is other end to the pipe 106. The connection of the inlet pipe 114 to the pipe 106 is made along the length of the pipe 106, at a hole 118 in the cylindrical wall of the pipe 106. The connection of the inlet pipe 114 with the pipe 106 and the cylindrical container 108 permits fluids A in the inlet of the pipe 106 to flow out of the pipe 106, into the inlet pipe 114 via the hole 118, through the inlet pipe 114, and out of the inlet pipe 114 into the container 108 via the inlet hole 108a. The inlet pipe 114 is fixed with a valve 116a and a pressure gauge 116b. The valve 116a and the pressure gauge 116b permit regulation of the fluids A flowing into the inlet pipe 114 and, thus, the container 108. The valve 116a can be manually adjustable by a human caretaker, or otherwise can be automated in whole or part. The pressure gauge 116b indicates to the human caretaker, or can be an indicator to a logical block or mechanism in an automated design, information about the fluids A flowing into the inlet pipe 114 and container 108 from the pipe 106.

Within the cylindrical container 108 is located a solid, porous substance 122, such as palletized, granular, or powdered chemicals, for mixing with the fluids A which flow into the container 108 via the hole 108a from the pipe 106. The substance 122 is mixed with the fluids A as they enter the container 108. The fluids A flow through the interstices of the substance, thereby mixing with and either dissolving or carrying the substance 122 within the fluids A. The fluids A, containing the dissolved or carried substance 122, exit the container 108 through the hole 108b and re-enter the pipe 106. In this manner, the fluids A flowing into the pipe 106 are carriers of the substance 122 as the exiting fluids A′ flowing out of the pipe 106.

The second reservoir 104 is, for example, a square container 130 vertically affixed atop the pipe 106. The square container 130 include a round cap 132, which can snap on, screw thread, or other design to sealingly close a loading opening in the top of the container 130. The round cap 132 can include a pressure vent or other ventilation arrangement to permit escape of any off-gases from the contents of the container 130.

At a bottom of the square container 130 at the pipe 106, the square container 130 is formed with an inlet feature 130a and an outlet feature 130b. The inlet feature 130a can be a hole in the container 130 which is filled by an inlet spray pipe 136. The inlet spray pipe 136 extends upwardly within the square container 130 above any contents of the container 130. The extended end of the spray pipe 136 includes an attached sprayer fixture 138. The sprayer fixture 138 disperses any inlet fluids A from the pipe 106, over contents of the container 130.

The inlet feature 130a of the container 130 can also include an inlet pipe portion 140 that extends outside the square container 130 into the interior of the pipe 106 in the flow of the fluids A therein. The inlet pipe portion 140 connects with the inlet spray pipe 136 and, in fact, can be merely an extension of the pipe 136 out of the container 130 into the pipe 106 or another extension arrangement. In any event, the inlet pipe portion 140 and the inlet spray pipe 136 serve to permit fluids A to flow from within the pipe 106 into the square container 130. An inlet valve 142 is fixed with the inlet pipe portion 140 to regulate the flow of the fluids A from the pipe 106 into the container 130. The valve 142 can be manually or automatically operable, as desired for the application. Moreover, the valve 142 can, in certain applications, include a rotatable head that extends through and outside of the pipe 106 to enable the valve 142 adjustment.

The square container 130 also includes an outlet feature 130b. The outlet feature 130b permits fluids A that enter the container 130 to flow out of the container 130 back into the pipe 106 as fluids A′ after mixing with contents of the container 130. The outlet feature 130b can, but need not necessarily, include an extension pipe 144 of similar extension to pass the fluids A′ from the outlet feature 130b into fluids flowing through the pipe 106. An outlet valve 146 is fixed with the outlet feature 130b or the extension pipe 144, as the case may be, and regulates the flow of fluids A′ from the container 130 to the pipe 106. As with the inlet valve 142, the outlet valve 152 can be manual or automated and can include an extension that protrudes through the pipe 106 wall to permit adjustment of the outlet valve 152 by a rotatable head located outside the pipe 106.

As has been briefly alluded to in the foregoing, the reservoirs 102, 104 can be respectively loaded with various chemicals or other substances. Particularly, these chemicals or other substances can be matters that are mixable with fluids, such as water, flowing through the pipe 106. In certain applications, fertilizer, herbicide, pesticide or other substance for mixing with fluids A flowing through the pipe 106 are loaded through the respective top-most openings of the reservoirs 102, 104. The fluids A flow into one or both of the reservoirs 102, 104, as regulated by valves or other mechanisms associated with the inlets to the reservoirs 102, 104. Within the reservoirs 102, 104, any substances contained therein mix with the input fluids A. The mixed fluids A′, which can include dissolved, dispersed or otherwise mixed substances of the reservoir 102, 104, then flow out of the reservoir 102, 104 and back into the pipe 106 as the fluids A′.

In operation, the reservoir 102 is particularly configured for containing solid substances 122, such as, for example, palletized, granular, powdered or other porous media. Fluids A, such as water, flow into the cylindrical container 108 of the reservoir 102 via the hole 118 of the inlet pipe 114 and the flow is regulated using the valve 116a and gauge 116b. The fluids A travel into the container 108 at a lower portion thereof and then rise within the container 108. As the fluids A travel within the container 108, the fluids A mix with the substances 122 and the fluids A become saturated with the substances 122, thus, designated as fluids A′.

The fluids A′ then flow out of the container 108 and back into the pipe 106. In the pipe 106, the fluids A′ mix with other flows within the pipe 106, including flows that do not enter the container 108. By controllingly regulating the fluids A that flow into the container 108, the extent of the substances 122 contained within the fluids A′ and, thus, flowing within the pipe 106 as fluids A′, is maintained as desired. The valve 116a and gauge 116b permit the desired regulation, and enable a caretaker or automated equipment (not shown) to dictate the amount of the substances 122 carried within the fluids A′. In this manner, the system 100 enables automatic dispersion of chemicals or other substances via water, or other fluids, flowing through and out of the pipe 106. Of course, the system 100 can be integrated with additional hosing or piping, such as a garden hose or fixed home sprinkler network, in order to disperse the substances on the lawn or tract fed by the hosing or piping.

The reservoir 104 operates in similar manner, although the reservoir is particularly designed for containing liquid chemical or other liquid substances 148, such as liquid fertilizer, liquid pesticide, liquid herbicide or other matter. In the square container 130 of the reservoir 104, fluids A from the pipe 106, such as water, flow into the square container 130 of the reservoir 104 via the inlet pipe portion 140 or otherwise through the hole fixture 130a. The fluids A then pass through the inlet spray pipe 136 and exit the pipe 136 in such manner as to disperse atop the contents of the container 130. The sprayer head 138 causes the fluids A to disperse as desired for the application. Flows into the container 130 are regulated using the valve 142, for example, automatically or manually, by rotating or otherwise manipulating the 142 through an external rotating head or other adjustment mechanism.

The dispersed fluids A in the container 130 then intermingle with the liquid substances 148 or other contents of the container 130, including, for example, by mixing and settling with and throughout the liquid substances 148. In such manner, the fluids A mix with the substances 148 and the fluids A become saturated with the substances 148, thus, designated as fluids A′. The fluids A′ then flow out of the container 130 and back into the pipe 106. In the pipe 106, the fluids A′ mix with other flows within the pipe 106, including flows that do not enter the container 130. By controllingly regulating the fluids A that flow into the container 130, the extent of the substances 148 contained within the fluids A′ and, thus, flowing within the pipe 106 as fluids A′, is maintained as desired. The valve 142 permits the desired regulation, and enables a caretaker or automated equipment (not shown) to dictate the amount of the substances 148 intermingled and mixed to be the fluids A′. The exiting fluids A′ from the container 130 pass back into the pipe 106 and can be regulated by the outlet 144 and valve 146. The valve 146 limits the flows from the container 130, so that the liquid substances 148 in the container are combined to form the fluids A′ saturated as desired. The system 100, via the reservoir 104, therefore, enables automatic dispersion of liquid chemicals or other liquid substances via water, or other fluids, flowing through and out of the pipe 106. Of course, as previously mentioned, the system 100 can be integrated with additional hosing or piping, such as a garden hose or fixed home sprinkler network, in order to disperse the substances on the lawn or tract fed by the hosing or piping.

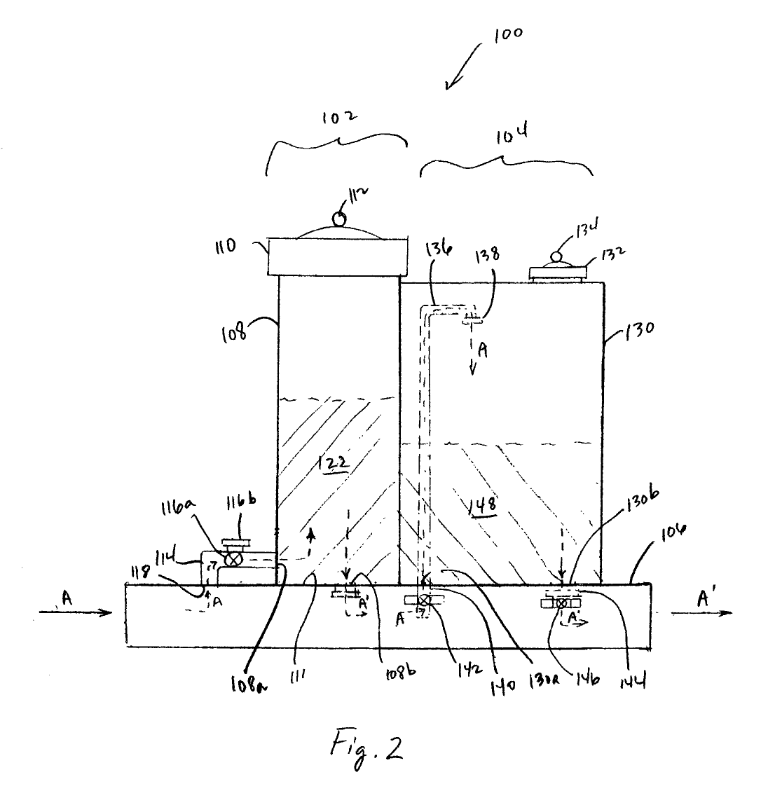

Referring to FIG. 2, each of the reservoirs 102, 104 of the system 100 is affixed atop the pipe 106. The inlet hole 108a connected to the container 108 serves for input of fluids A traveling from the pipe 106 through the hole 118 of the inlet pipe 114. The valve 116a and gauge 116b permit regulation of the fluids A so flowing through the pipe 114. The fluids A mix with the substance 122 contained within the container 108. Mixed fluids A′ flow out of the container 108 through the hole 108b and back into the pipe 106.

The inlet pipe portion 140 feeds the container 130 from the fluids A in the pipe 106, as such feed is regulatable by the valve 142 of the portion 140. The fluids A travel upward through the inlet spray pipe 136 and exit the pipe 136 into the container 130 through the affixed sprayer fixture 138. The sprayingly dispersed fluids A mix with the substances 148 in the container 148. Mixed fluids A′ flow out of the container and back into the pipe 106 through the extension pipe 144 as regulated by the outlet valve 146.

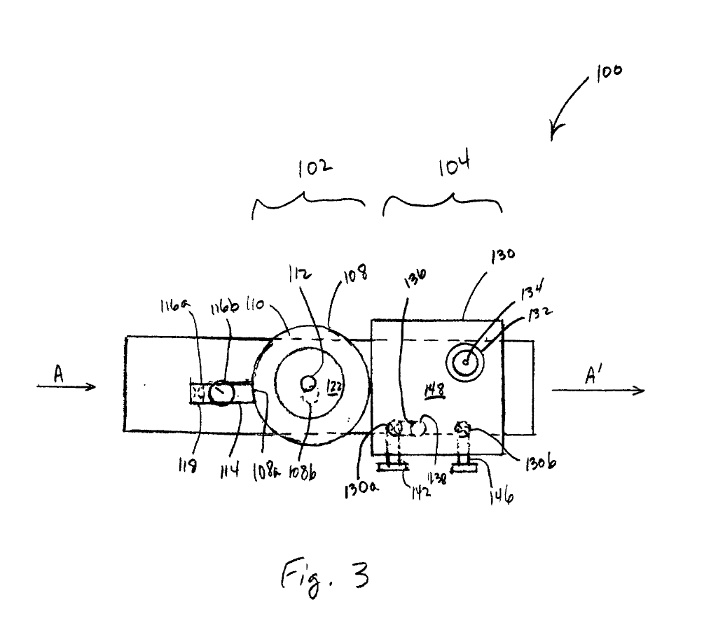

Referring to FIG. 3, fluids A, for example, water, enter the pipe 106 at an end thereof. The fluids A are intended for watering or other dispersing on a tract of land, such as a homeowner's lawn. The fluids A travel through the pipe 106 and at least portions of the fluids A pass into and out of one or both of the reservoirs 102, 104. At the reservoir 102, 104, the fluids A are combined with the substance 122, 148 contained in the reservoir 102, 104. The fluids A′ as so combined with the substance 122, 148 pass back to the pipe 106 from the reservoir 102, 104. In the pipe 106, the fluids A′ mix with other flowing fluids A to become the fluids A′. The fluids A′ then pass out of the pipe 106.

As has been discussed, the inlet pipe 114, connected between the hole 118 of the pipe 106 and the hole 108a of the cylindrical container 108, provides passage for the fluids A into the cylindrical container 108, as permitted by the valve 116a according to the desired reading of the gauge 116b. The fluids A′ saturated with the substance 122 contained in the container 108 pass from the container 108 back to the pipe 106 through the hole 108b. Similarly, the inlet spray pipe 136 connects with the hole 130a of the pipe 106 and permits fluids A to flow from the pipe 106 into the square container 130. The sprayer fixture 138 disperses the fluids A within the container 130. The fluids A mix in the container with the substances 148 to yield the fluids A′. The fluids A′ flow out of the container 130 back into the pipe 106 through the hole 130b. The respective valves 142, 146 regulate flows of the fluids A and the fluids A′, respectively, into and out of the container 130.

Numerous variations are possible in the foregoing embodiments and operations. For example, only a single one of the reservoirs 102, 104 may be employed if both are not then required. Although the reservoir 102 is designed for effective operations with solid substances, such as palletized, granularized, powdered or similar chemicals, variations are possible with the same effect and alternatively other solid, liquid, gaseous, or multi-phase substances could be used. The reservoir 104 is designed particularly for operations with liquid substances, such as liquid fertilizers, liquid pesticides, liquid herbicides or the like, however, variations of the substances, including solids, gases and multiphase substances are also possible in certain and other configurations. In fact, even a single reservoir is possible in the system 100. Alternatively, the system 100 can function as though having a single reservoir if the inlet and outlet valves regulating the fluids A from the pipe 106 into the respective containers 108, 130 are closed off or otherwise adjusted as desired for the particular application.

The system 100 can be integral to a water piping network, such as the type system of PVC piping and sprinkler heads employed in the conventional automated lawn watering system. In such an application, the pipe 106 can be fitted and affixed with other piping at the inlet and outlet, such as PVC piping or other plumbing fixtures. Conventional mating adhesives and processes, or even alternative configuration designs, are all possible. Moreover, the system 100 can include appropriate male or female threadings and couplings for screwingly connecting the system 100 with garden hoses, piping, plumbing fixtures, and the like. In such a system 100, the system 100 can be attached, removed, moved, and refitted as desired for diverse locations and applications.

Widely varied materials and construction can be employed in keeping with the embodiments and operations of the system 100. For example, the system 100, including the pipe 106 and the reservoirs 102, 104, can each be moulded, pieced together, welded, fused, glued or otherwise constructed. Each of the features can be made from any of a wide variety of materials, including such materials as plastics, PVCs, steel, copper, or other similar substances conventionally or otherwise employable in gardening and lawn caretaking systems. The valves and vents of the system 100 can be any of a wide variety of mechanically operable elements that perform the desired operations of limiting, diverting or restricting flows, maintaining substances including solids, liquids, gases and multiphase matters, indicators and instrumentation, automated or manual selectors and adjusters, and numerous other functional elements and operations as desired. Of course, where corrosive or otherwise potentially damaging chemicals or substances may be employed either for dispersion in the fluids A′ or in the environmental location of the system 100, elements, features, and configurations, as well as materials and compositions of all elements and parts, must be suitable to support the application.

Further automation and convenience is also possible in the system 100. For example, the system 100 can be controlled by conventional or future control and instrumentation systems and processes. Timers and similar measurement or operational devices and features can be added or substituted to permit the further automation. A particularly advantageous nuance for the system 100, for example, could be automation of the valves and measurement and combination with conventional tract sprinkler controls and systems. Control of the system 100 can be local to the system 100, or possibly remote to the system 100 in certain variations. Even though the system 100 has been described herein as primarily intended for lawn and garden caretaking and use, the system 100 can be varied for larger scale and different applications, including any applications in which a carrier fluid (e.g., including liquid or gas) is mixed with a substance (e.g., including liquid, gas, solid or other) and then dispersed.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention.

Benefits, other advantages, and solutions to problems have been described above with regard to specific embodiments. However, the benefits, advantages, solutions to problems and any element(s) that may cause any benefit, advantage, or solution to occur or become more pronounced are not to be construed as a critical, required, or essential feature or element of any or all the claims. As used herein, the terms “comprises, “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A chemical dispersion system for transporting a liquid, comprising:
a liquid conduit;
a reservoir flowingly connected to the liquid conduit; and
a mechanism for regulating flows from the liquid conduit through the reservoir and back into the liquid conduit.

2. The chemical dispersion system of claim 1, wherein the reservoir contains a substance selected from the group consisting of: solid, gas, liquid, and multiphase.

3. The chemical dispersion system of claim 1, wherein the mechanism regulates flows into the reservoir.

4. The chemical dispersion system of claim 1, wherein the mechanism regulates flows from the reservoir.

5. The chemical dispersion system of claim 1, comprising:
a second reservoir flowingly connected to the liquid conduit; and
a second mechanism for regulating flows from the liquid conduit through the second reservoir and back into the liquid conduit.

6. The chemical dispersion system of claim 5, further comprising:
a solid chemical maintained within the reservoir, wherein flows from the liquid conduit into the reservoir mix with the solid chemical and saturate flows out of the reservoir back into the liquid conduit.

7. The chemical dispersion system of claim 1, further comprising a chemical maintained within the reservoir for mixing with the flows from the liquid conduit selected from the group consisting of: fertilizer, herbicide, and pesticide.

8. The chemical dispersion system of claim 6, wherein the solid chemical is selected from the group consisting of: pellets, granules, powder, and other porous media.

9. The chemical dispersion system of claim 5, wherein the reservoir serves for containing a solid chemical and the second reservoir serves for containing a liquid chemical.

10. The chemical dispersion system of claim 9, wherein the solid chemical has a different composition than the liquid chemical.

11. A system for mixing a substance with a flowing liquid, comprising:
a pipe containing the flowing liquid;
a first reservoir connected to the pipe for receiving at least a portion of the flowing liquid, the first reservoir contains the substance and permits the substance to mix with the flowing liquid, and the flowing liquid after mixing with the substance flows from the first reservoir into the pipe.

12. The system of claim 11, further comprising:
a second reservoir connected to the pipe for receiving at least a portion of the flowing liquid, the second reservoir contains the substance and permits the substance to mix with the flowing liquid, and the flowing liquid after mixing with the substance flows from the second reservoir into the pipe.

13. The system of claim 12, wherein each of the first reservoir and the second reservoir contain different ones of the substance selected from the group consisting of: fertilizer, herbicide and pesticide.

14. The system of claim 12, wherein each of the first reservoir and the second reservoir contain different ones of the substance selected from the group consisting of: solid, liquid, gas and multiphase.

15. A method of dispersing a chemical in a liquid, comprising the steps of:
retaining the chemical in a container;
flowing the liquid in a conduit;
passing at least a portion of the liquid from the conduit into the container;
mixing the liquid with the chemical in the container; and
passing the liquid as mixed with the chemical back into the conduit.

16. The method of claim 15, wherein the chemical is selected from the group consisting of: solid, liquid, gas, and multiphase.

17. The method of claim 15, further comprising the step of:
controlling an extent of saturation of the chemical in the liquid.

18. The method of claim 15, wherein the chemical is selected from the group consisting of: fertilizer, herbicide, and pesticide.

19. The method of claim 15, further comprising the steps of:
retaining the chemical in a second container;
passing at least a portion of the liquid from the conduit into the second container;
mixing the liquid with the chemical in the second container; and passing the liquid as mixed with the chemical back into the conduit.

20. The method of claim 19, wherein the container contains a first chemical and the second container contains a second chemical.

21. The method of claim 20, further comprising the steps of:
controlling an extent of saturation of the first chemical in the liquid; and
controlling an extent of saturation of the second chemical in the liquid.

22. The method of claim 21, wherein the method waters a tract of land.

23. The system of claim 1, wherein the chemical dispersion system further comprises a watering conduit for a tract of land.
